(19) United States
(12) Patent Application Publication
(10) Pub. No.: US 2007/0294091 A1
(43) Pub. Date: Dec. 20, 2007

(54) Responding to advertisement-adverse content or the like

(75) Inventors: Alexander J. Cohen, Mill Valley, CA (US); Edward K.Y. Jung, Bellevue, WA (US); Royce A. Levien, Lexington, MA (US); Robert W. Lord, Seattle, WA (US); Mark A. Malamud, Seattle, WA (US); William Henry Mangione-Smith, Kirkland, WA (US); John D. Rinaldo JR., Bellevue, WA (US); Clarence T. Tegreene, Bellevue, WA (US)

Correspondence Address: SEARETE LLC;CLARENCE T. TEGREENE, 1756 - 114TH AVE., S.E., SUITE 110, BELLEVUE, WA, 98004, US

(73) Assignee: Searete LLC, a limited liability corporation of the State of Delaware

(21) Appl. No.: 11/432,762

(22) Filed: May 10, 2006

(51) Int. Cl. G06Q 10/00; G07G 1/14; G06Q 30/00

(52) U.S. Cl. 705/1; 705/14

(57) ABSTRACT

A method and system are described for obtaining a relation between a visual display and an advertisement-adverse-content indication or for indicating a linkage between a local delivery of mobile-device content and a commercial purpose. The method and system may also relate to invoking circuitry for signaling whether to cause one or more cognitive symbols substantially to vanish from the visual display responsive to the obtained relation between the visual display and the advertisement-adverse-content indication, circuitry for responding locally to the indicated linkage between the local delivery of mobile-device content and the commercial purpose, or circuitry for signaling whether to transmit a message outside the visible-display zone responsive to the obtained relation between the visible-display zone and the advertisement-adverse-content indication.

### SUMMARY

An embodiment provides a method. In one implementation, the method includes but is not limited to obtaining a relation between a visual display and an advertisement-adverse-content indication and invoking circuitry for signaling whether to cause one or more cognitive symbols substantially to vanish from the visual display responsive to the obtained relation between the visual display and the advertisement-adverse-content indication. In addition to the foregoing, other method aspects are described in the claims, drawings, and text forming a part of the present disclosure.

In one or more various aspects, related systems include but are not limited to circuitry and/or programming for effecting the herein-referenced method aspects; the circuitry and/or programming can be virtually any combination of hardware, software, and/or firmware configured to effect the herein-referenced method aspects depending upon the design choices of the system designer.

An embodiment provides a system. In one implementation, the system includes but is not limited to circuitry for obtaining a relation between a visual display and an advertisement-adverse-content indication and circuitry for signaling whether to cause one or more cognitive symbols substantially to vanish from the visual display responsive to the obtained relation between the visual display and the advertisement-adverse-content indication. In addition to the foregoing, other system aspects are described in the claims, drawings, and text forming a part of the present disclosure.

An embodiment provides a method. In one implementation, the method includes but is not limited to indicating a linkage between a local delivery of mobile-device content and a commercial purpose and invoking circuitry for responding locally to the indicated linkage between the local delivery of mobile-device content and the commercial purpose for signaling whether to cause one or more cognitive symbols substantially to vanish from the visual display responsive to the obtained relation between the visual display and the advertisement-adverse-content indication. In addition to the foregoing, other method aspects are described in the claims, drawings, and text forming a part of the present disclosure.

In one or more various aspects, related systems include but are not limited to circuitry and/or programming for effecting the herein-referenced method aspects; the circuitry and/or programming can be virtually any combination of hardware, software, and/or firmware configured to effect the herein-referenced method aspects depending upon the design choices of the system designer.

An embodiment provides a system. In one implementation, the system includes but is not limited to circuitry for indicating a linkage between a local delivery of mobile-device content and a commercial purpose and circuitry for responding locally to the indicated linkage between the local delivery of mobile-device content and the commercial purpose. In addition to the foregoing, other system aspects are described in the claims, drawings, and text forming a part of the present disclosure.

An embodiment provides a method. In one implementation, the method includes but is not limited to obtaining a relation between a visible-display zone and an advertisement-adverse-content indication and invoking circuitry for signaling whether to transmit a message outside the visible-display zone responsive to the obtained relation between the visible-display zone and the advertisement-adverse-content indication. In addition to the foregoing, other method aspects are described in the claims, drawings, and text forming a part of the present disclosure.

In one or more various aspects, related systems include but are not limited to circuitry and/or programming for effecting the herein-referenced method aspects; the circuitry and/or programming can be virtually any combination of hardware, software, and/or firmware configured to effect the herein-referenced method aspects depending upon the design choices of the system designer.

An embodiment provides a system. In one implementation, the system includes but is not limited to circuitry for obtaining a relation between a visible-display zone and an advertisement-adverse-content indication and circuitry for signaling whether to transmit a message outside the visible-display zone responsive to the obtained relation between the visible-display zone and the advertisement-adverse-content indication. In addition to the foregoing, other system aspects are described in the claims, drawings, and text forming a part of the present disclosure.

In addition to the foregoing, various other embodiments are set forth and described in the text (e.g., claims and/or detailed description) and/or drawings of the present description.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE FIGURES

FIGS. 1-3 each depicts an exemplary environment in which one or more technologies may be implemented.

FIG. 4 depicts a high-level logic flow of an operational process.

FIG. 5 depicts another high-level logic flow of an operational process.

FIG. 6 depicts yet another high-level logic flow of an operational process.

FIG. 7 depicts another exemplary environment in which one or more technologies may be implemented.

FIG. 8 depicts yet another exemplary environment in which one or more technologies may be implemented.

FIG. 9 depicts still another exemplary environment in which one or more technologies may be implemented.

FIGS. 10-15 each depict variants of the flows of FIGS. 2-4.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here.

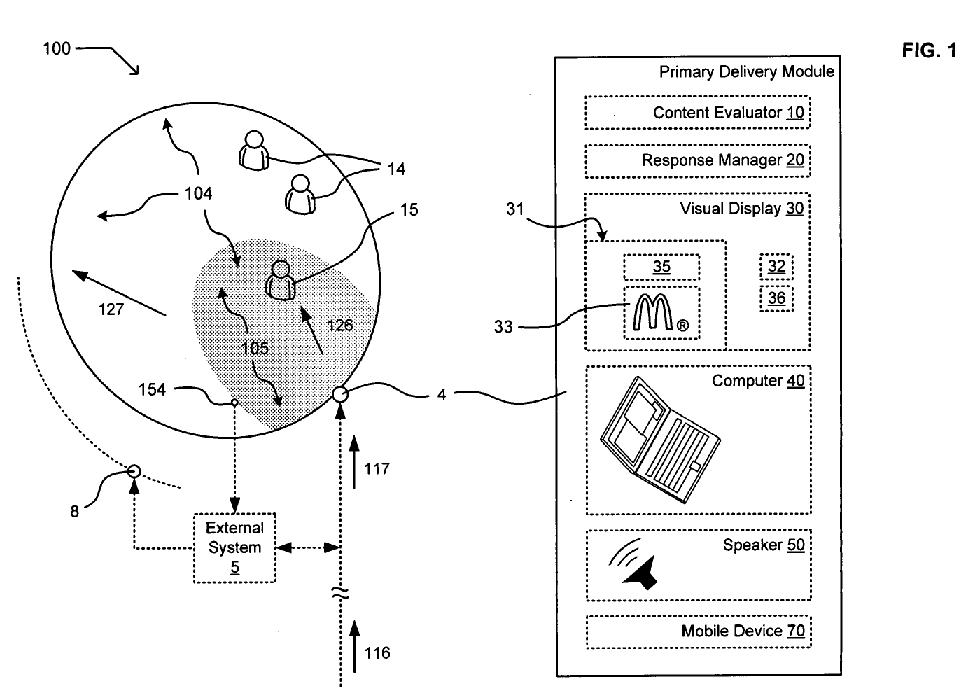

Referring now to FIG. 1, there is shown an exemplary environment in which one or more technologies may be implemented. As shown system 100 comprises primary delivery module 4 shown physically (to the left) and schematically (to the right). In some embodiments primary delivery module 4 emits visible or other observable content 126 within a vicinity 105 of primary delivery module 4, so that one or more individuals 15 within vicinity 105 can observe the content 126. Primary delivery module 4 can also emit optical, acoustic, or other artificially detectable content 127 within a larger vicinity 104 of primary delivery module 4, so that one or more optional sensors 154 can detect the content 127 but other individuals 14 might not.

System 100 may receive input data 116 as arriving data 117 via primary delivery module 4. In some embodiments, external system 5 is provided and configured for one or more of (a) exchanging data with primary delivery module 4, (b) receiving data from one or more optional sensors 154, or (c) providing data to external delivery module 8. As noted below, any of these features may optionally be duplicated in embodiments described herein, but are exemplified in simple fashion here.

As system 100 shows schematically, primary delivery module 4 can include one or more of content evaluator 10, response manager 20, visual display 30, computer 40, speaker 50, or mobile device 70. Visual display 30 can optionally include one or more of unrecognized content 35, one or more cognitive symbols 32 comprising an ad or message, a logo 33 or logo-containing region, one or more advertiser-specific symbols 36, or one or more transitions 31 bounding regions of the display screen.

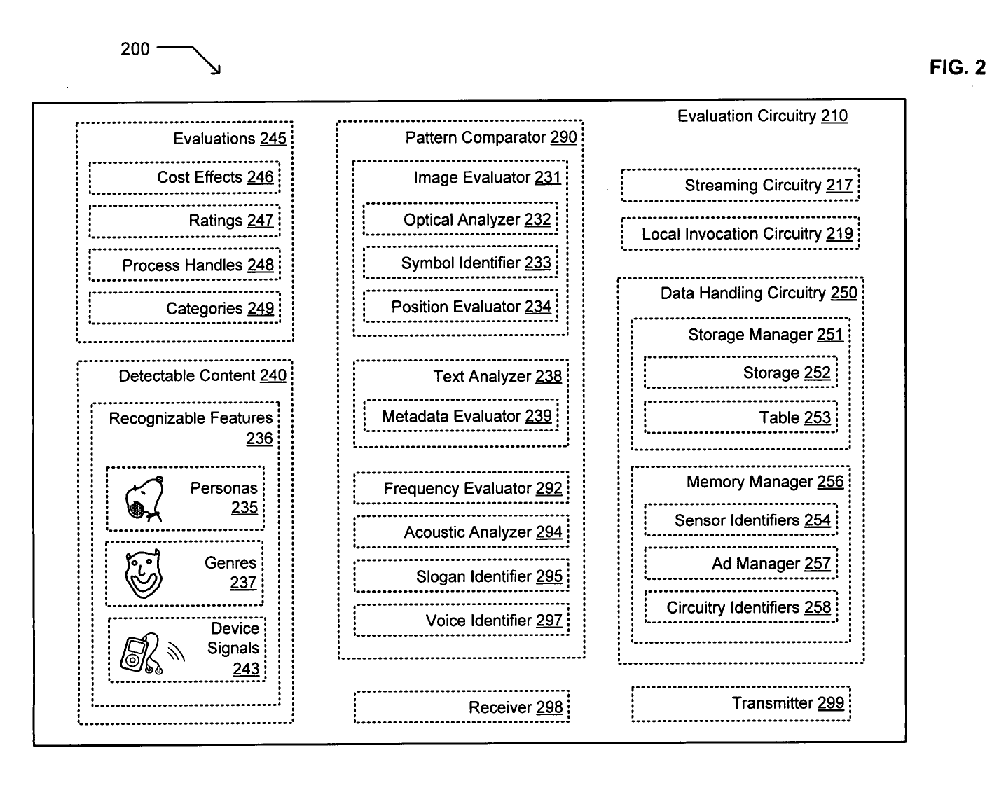

Referring now to FIG. 2, there is shown an exemplary environment in which one or more technologies may be implemented. As shown system 200 comprises evaluation circuitry 210 that can optionally implement content evaluator 10 of FIG. 1. Evaluation circuitry 210 can include one or more of detectable content 240, evaluations 245, pattern comparator 290, streaming circuitry 217, local invocation circuitry 219, data handling circuitry 250, receiver 298, or transmitter 299. Detectable content 240 can optionally include (one or more) personas 235, genres 237, device signals 243, recognizable features 236, or the like. Evaluations 245 can optionally include (one or more) cost effects 246, ratings 247, process handles 248, categories 249, or the like.

Pattern comparator 290 can include one or more of image evaluator 231, text analyzer 238, frequency evaluator 292, acoustic analyzer 294, slogan identifier 295, or voice identifier 297. Image evaluator 231 can include one or more of optical analyzer 232, symbol identifier 233, or position evaluator 234. Text analyzer 238 can optionally include metadata evaluator 239. In some embodiments, one or more items in pattern comparator 290 indicate or cause a transmission of recognizable features 236 or evaluations 245 responsive to detectable content 240 provided via receiver 298, for example.

Data handling circuitry 250 can optionally include one or more of storage manager 251 or memory manager 256. Storage manager 251 can optionally include storage 252 or table 253. Memory manager 256 can optionally include sensor identifiers 254, ad manager 257, or circuitry identifiers 258.

Those skilled in the art will recognize that some of these items can overlap. Voice identifier 297 can optionally be implemented as a portion of memory containing one or more instructions, for example, partly or wholly within one or more instructions that implement acoustic analyzer 294, in some embodiments. Also, any or all of the items shown in evaluation circuitry 210 can optionally be implemented as a portion of memory comprising one or more software instructions of a computer program product accessible by a processor.

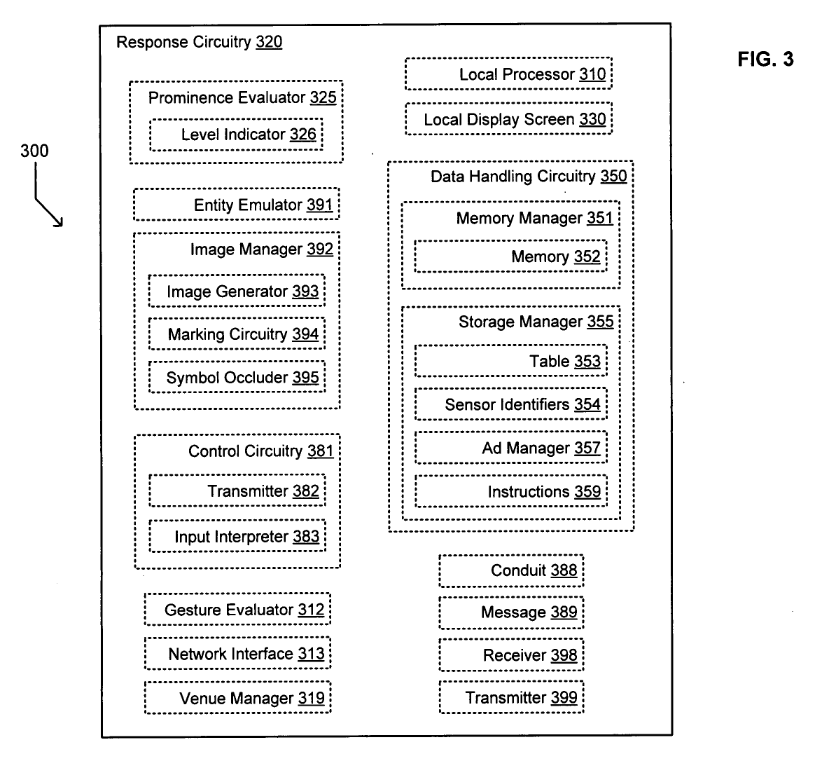

Referring now to FIG. 3, there is shown an exemplary environment in which one or more technologies may be implemented. As shown system 300 comprises response circuitry 320 optionally including one or more of prominence evaluator 325, level indicator 326, entity emulator 391, image manager 392, control circuitry 381, gesture evaluator 312, network interface 313, venue manager 319, local processor 310, local display screen 330, data handling circuitry 350, conduit 388, message 389, receiver 398, or transmitter 399. Image manager 392 optionally includes one or more of image generator 393, marking circuitry 394, or symbol occluder 395. Control circuitry 381 optionally includes one or more of transmitter 382 or input interpreter 383. Data handling circuitry 350 optionally includes one or more of memory manager 351 with memory 352 or storage manager 355. Storage manager 355 optionally includes one or more of table 353, sensor identifiers 354, ad manager 357, or instructions 359.

Those skilled in the art will recognize that some of these items can overlap. Also, any or all of the items shown in response circuitry 320 can optionally be implemented as a portion of memory comprising one or more software instructions of a computer program product accessible by a processor.

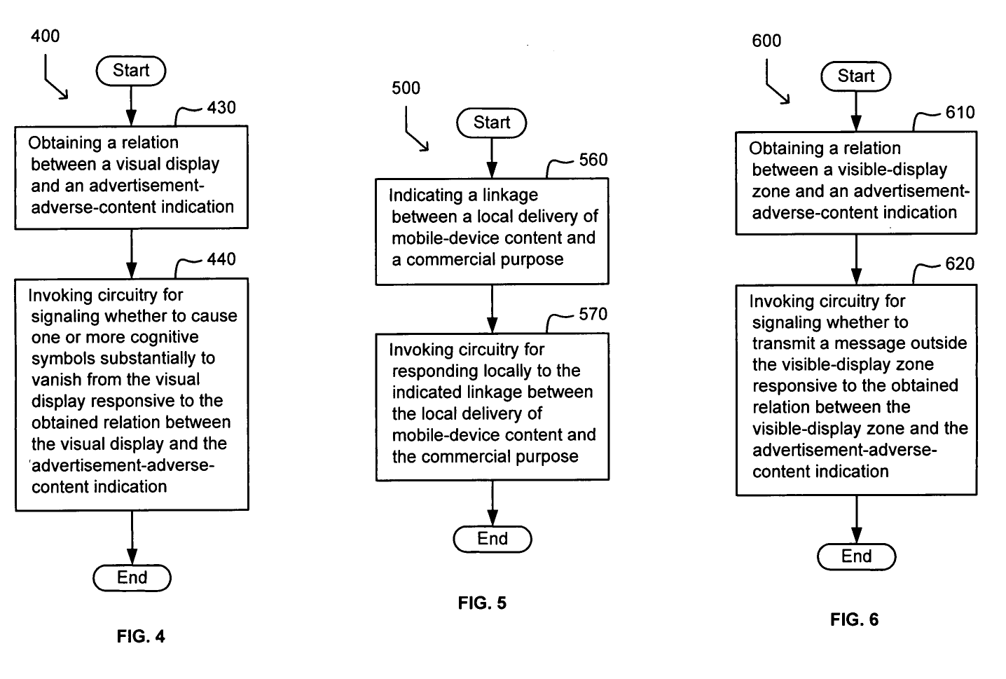

Referring now to FIG. 4, there is shown a high-level logic flow 400 of an operational process. Operation 430 describes obtaining a relation between a visual display and an advertisement-adverse-content indication (e.g. content evaluator 10 signaling that visual display 30 has an adversity score of 7.0, or a binary value of 1, either being useful for deciding whether to maintain a small “Wendy's®” ad including cognitive symbols 32 such as a logo). In some embodiments, unrecognized content 35 can be ignored responsive to one or more adversity-indicative symbols within a vicinity thereof, or within a common zone bounded by a transition (such as transition 31). In some embodiments, an adversity evaluation of a display screen or portion thereof (such as that bounded by transitions 31, e.g.) depends on a number of pixels or square centimeters in the zone, or of a logo within the zone or the like. Alternatively or additionally, such an adversity evaluation can be partly based on a score of a slogan, a sketch, an image position, an empirical poll response, an audience biometric or demographic, an arithmetic formula, or the like.

Operation 440 describes invoking circuitry for signaling whether to cause one or more cognitive symbols substantially to vanish from the visual display responsive to the obtained relation between the visual display and the advertisement-adverse-content indication (e.g. local invocation circuitry 219 invoking response circuitry 320 for deciding that an adversity score of 7.0 is too high and accordingly removing cognitive symbols 32 comprising the small “Wendy's®” ad). In some embodiments a local computer (such as computer 40, e.g.) comprises one or both of evaluation circuitry 210 and response circuitry 320, for example. Optionally the “signaling” can be performed, for example, in responding to the relation by displaying an image sequence in which a phrase or logo scrolls or otherwise moves off screen.

Referring now to FIG. 5, there is shown a high-level logic flow 500 of another operational process. Operation 560 describes indicating a linkage between a local delivery of mobile-device content and a commercial purpose (e.g. voice identifier 297 recognizing a Lyle Lovett song playing from device signals 243 sensed by one or more sensors 154 at least partly within a vicinity of a music source). In some embodiments, the music source can be a pair of headphones or other mobile device 70 implementing primary delivery module 4 or content evaluator 10, for example.

Operation 570 describes invoking circuitry for responding locally to the indicated linkage between the local delivery of mobile-device content and the commercial purpose (e.g. local invocation circuitry 219 invoking response circuitry 320 for advertising a Lyle Lovett movie or album in or to a vicinity of the music source). In some embodiments, the response circuitry responds substantially without requiring remote and/or human approval, sufficiently quickly so that the response can arrive within about a minute (perhaps before the Lyle Lovett song ends and/or primary delivery module 4 leaves the premises, for example). In some embodiments, the circuitry can comprise local transistors or other active elements, together with conduits and other passive media therebetween.

Referring now to FIG. 6, there is shown a high-level logic flow 600 of another operational process. Operation 610 describes obtaining a relation between a visible-display zone and an advertisement-adverse-content indication (e.g. one or more items of pattern comparator 290 identifying one or more festive genres 237 in a vicinity 105 within which a display image of primary delivery module 4 is visible). The identified genre may resolve to “rock music video,” which may cause a substantial increase in an estimate of advertisement adversity, for example, for a mortuary advertisement. Alternatively or additionally, pattern comparator 290 may assign one or more advertisement-adverse-content categories 249 (“noisy,” “wrong audience,” or a corresponding numerical category or the like).

Operation 620 describes invoking circuitry for signaling whether to transmit a message outside the visible-display zone responsive to the obtained relation between the visible-display zone and the advertisement-adverse-content indication (e.g. local invocation circuitry 219 invoking response circuitry 320 to send a client one or more captured images indicating a detected advertisement-adverse environment). Alternatively or additionally, response circuitry 320 can aggregate data describing the relation locally until a conclusion of a fixed time period (daily, e.g.) or until a user or other client requests the data.

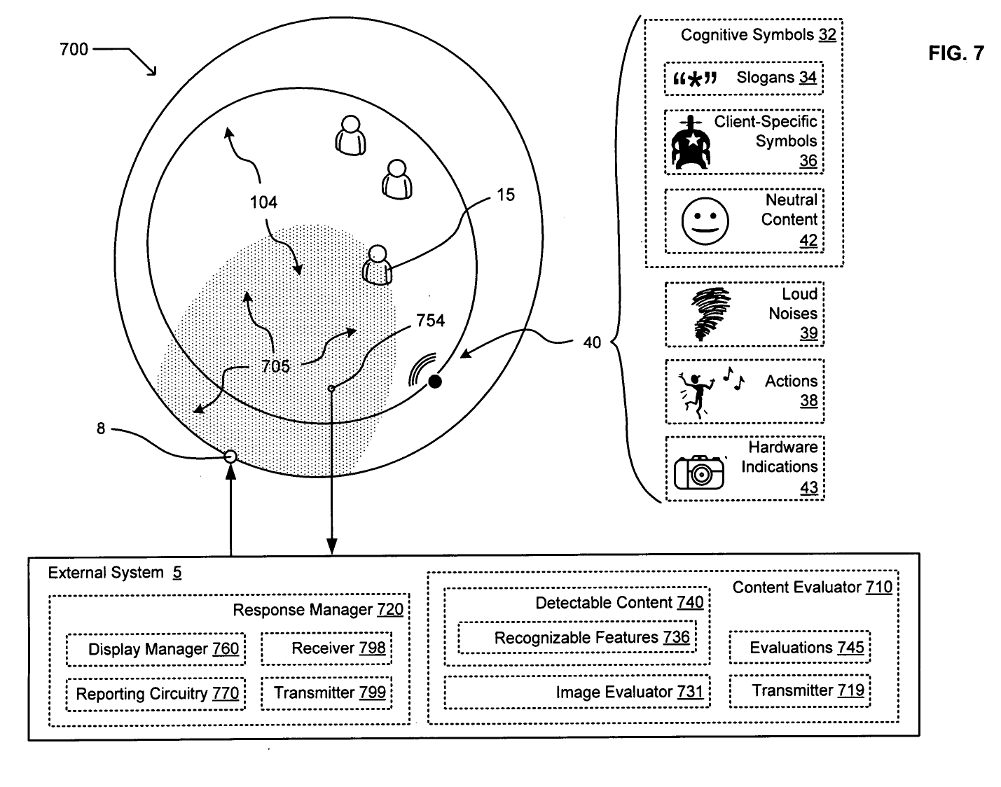

Referring now to FIG. 7, there is shown an exemplary environment in which one or more technologies may be implemented. As shown system 700 can include one or more phenomena 40, detectable at least within vicinity 104. These can include cognitive symbols 32, loud noises 39, actions 38, hardware indications 43, or the like. For example, the cognitive symbols can optionally include one or more of slogans 34, client-specific symbols 36, neutral content 42, or the like. (Those skilled in the art will recognize that not all neutral content includes a cognitive symbol, of course, and that not all loud noises lack cognitive symbols.)

In some embodiments detectable phenomena 40 can be artificially detected, for example, such as by one or more sensors 754 at least partly within a vicinity 104 of detectable phenomena 40. As shown, external system 5 can receive data from the one or more sensors 754. External system 5 can include content evaluator 710 that can include image evaluator 731 and evaluations 745 therefrom, detectable content 740 (including one or more recognizable features 736 as can be gleaned from detectable phenomena 40, e.g.). The recognizable features 736 can include heartbeats, spoken words, temporal transitions, high-draw attractions, solid color blocks, facial expressions, demographic indications, or the like. Content evaluator 710 can interpret cognitive symbols and other useful data in the detectable phenomena 40, and transmit associations relating to the data as described herein via transmitter 719. For example, the associations may include appropriate an appropriate image displayed at external delivery module 8. In some embodiments, external system 5 further comprises response manager 720. Response manager 720 can include one or more of display manager 760, reporting circuitry 770, receiver 798, or transmitter 799.

In some embodiments, system 700 implements at least flow 500 as shown in FIG. 5. Operation 560—indicating a linkage between a local delivery of mobile-device content and a commercial purpose—can be performed by content evaluator 710, for example. Detectable phenomena 40 may include a video segment relating to law enforcement on a portable display device, for example, which may coincide with one or more client-specific symbols 36. The client's commercial purpose of advertising an action movie relating to law enforcement may therefore be linked (thematically, e.g.) with the video segment display.

Operation 570 of flow 500—invoking circuitry for responding locally to the indicated linkage between the local delivery of mobile-device content and the commercial purpose—can be performed by transmitter 719 invoking response manager 720 for advertising the action movie to one or more individuals 15 in a vicinity 705 of external delivery module 8. Alternatively or additionally, content evaluator 710 can invoke response manager 720 for showing a camera shop advertisement responsive to hearing a shutter click sound (e.g. one or more hardware indications 43).

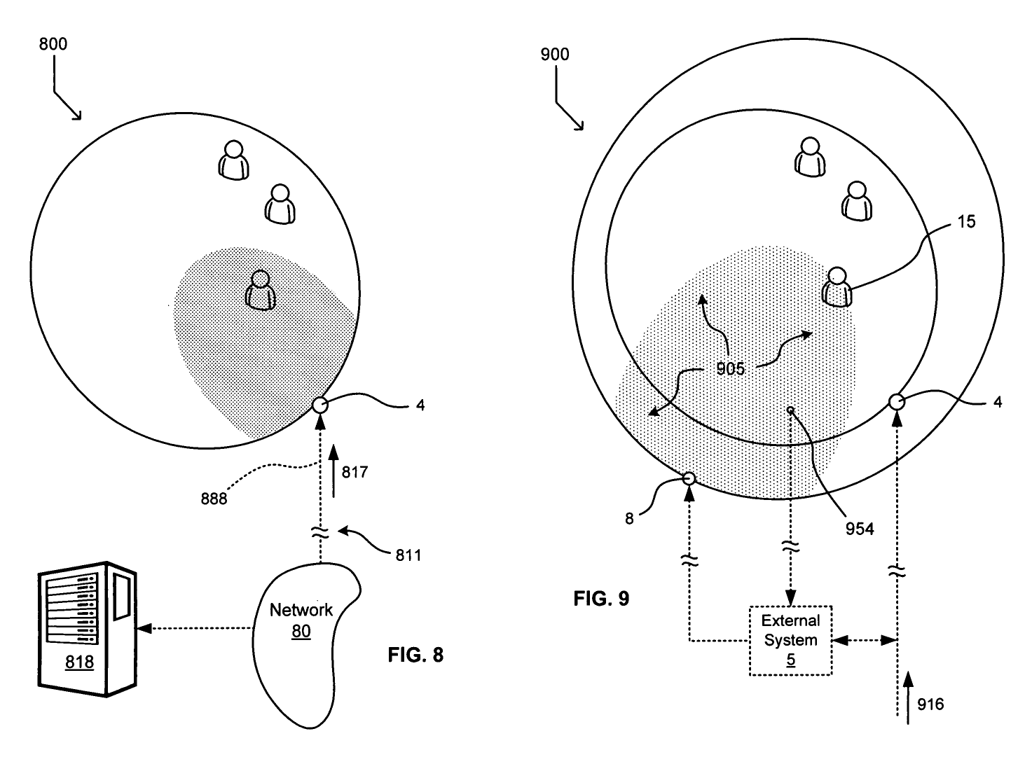

Referring now to FIG. 8, there is shown an exemplary environment in which one or more technologies may be implemented. As shown system 800 can comprise primary delivery module 4 delivering data 817 received from remote server 818 via remote network 80. In some embodiments, remote features comprise whatever features are not local and/or are depicted across an indeterminate portion 811 of conduit 888.

In some embodiments, system 800 implements at least flow 400 as shown in FIG. 4. Operation 430—obtaining a relation between a visual display and an advertisement-adverse-content indication—can be performed by evaluation circuitry 210, for example. Operation 440—invoking circuitry for signaling whether to cause one or more cognitive symbols substantially to vanish from the visual display responsive to the obtained relation between the visual display and the advertisement-adverse-content indication—can be performed by data handling circuitry 350 invoking at least transmitter 399 for changing, or signaling a change of, a display screen in primary delivery module 4. In some embodiments, primary delivery module 4 locally includes evaluation circuitry 210 and response circuitry 320, for example. In some embodiments, one or both of these are implemented remotely, such as in network 80.

Referring now to FIG. 9, there is shown an exemplary environment in which one or more technologies may be implemented. As shown system 900 can comprise input data 916 being delivered to external system 5 or directly via primary delivery module 4 to one or more individuals 15. Alternatively or additionally, external system 5 can receive data from sensor 954 indicating, for example, observable content or other detectable phenomena in a vicinity of primary delivery module 4 or one or more individuals 15. Alternatively or additionally, external system may provide content observable to one or more individuals 15 at least partly within a vicinity 905 of external delivery module 8. In some embodiments, system 900 implements at least flow 600 as shown in FIG. 6. Evaluation circuitry 210 or response circuitry 320 can each reside partly or wholly within primary delivery module 4, external system 5, or external delivery module 8, for example. In some embodiments, more than one of module 4, external system 5, or external delivery module 8 can include instances or portions of response circuitry 320 as shown in FIG. 3.

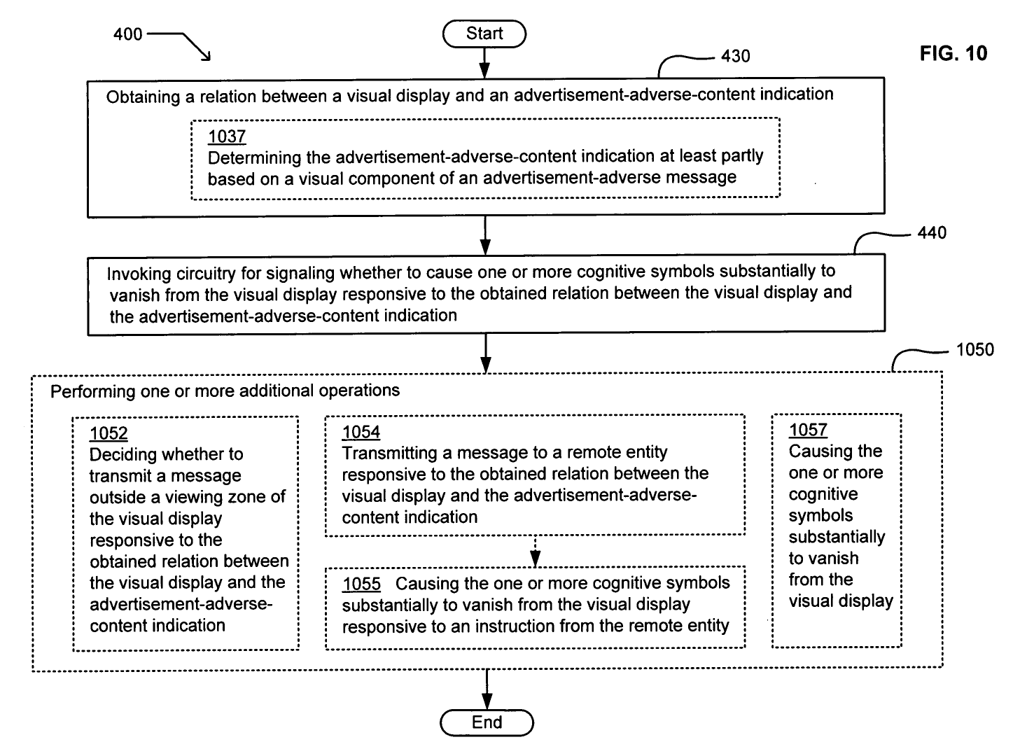

Referring now to FIG. 10, there are shown several variants of the flow 400 of FIG. 4. Operation 430—obtaining a relation between a visual display and an advertisement-adverse-content indication—may include (optional) operation 1037. Operation 1037 describes determining the advertisement-adverse-content indication at least partly based on a visual component of an advertisement-adverse message (e.g. image evaluator 731 of FIG. 7 identifying neutral cognitive symbols in a weather forecast display to generate one or more evaluations 745 indicating no advertisement-adversity in the display). Alternatively or additionally, operation 1037 can be performed in an embodiment like that shown in FIG. 8 or FIG. 9 incorporating evaluation circuitry 210. Transmitter 299 can indicate the advertisement-adverse-content indication, for example, as a binary rating (e.g. ratings 247 signaling “true” to prompt primary delivery module 4 to remove a poorly-placed ad).

Alternatively or additionally, flow 400 may include operation 1050—performing one or more additional operations (e.g. response circuitry 320 performing one or more of the following operations 1052, 1054, 1055, or 1057). This can occur, for example, in embodiments in which one or more optional items shown in FIG. 3 implement response manager 20 of FIG. 1.

Operation 1052 describes deciding whether to transmit a message outside a viewing zone of the visual display responsive to the obtained relation between the visual display and the advertisement-adverse-content indication (e.g. venue manager 319 relocating an ad in a remote visual display responsive to detecting adversity in a local visual display). Alternatively or additionally, reporting circuitry 770 can optionally decide to report one or more adversity types to a remote server responsive to a user preference (e.g. reporting circuitry 770 indicating “tarnishing” or “too busy” or “non-reactive,” for example, selected from among categories 249). Supporting data such as an adversity detection time or one or more sensor identifiers 254 can optionally be reported as well.

Operation 1054 describes transmitting a message to a remote entity responsive to the obtained relation between the visual display and the advertisement-adverse-content indication (e.g. transmitter 382 requesting a security verification or authorization from remote server 818 responsive to detecting that primary delivery module appears to comprise a highly adverse environment). Alternatively or additionally, system 800 can be configured to telephone or otherwise contact a primary user responsive to detecting the highly adverse environment.

Operation 1055 describes causing the one or more cognitive symbols substantially to vanish from the visual display responsive to an instruction from the remote entity (e.g. input interpreter 383 and marking circuitry 394 jointly responding to a valid password and removal authorization by marking the one or more cognitive symbols digitally so that it will vanish). In some embodiments, the vanishing can be implemented in a subsequent refresh operation, after a completion of a message in progress, or at some other opportune time. These types of embodiments can be appropriate for ensuring security for an upcoming political election, for example, in which removing an embarrassing ad can be significant or in which a hacker may try to trick an automatic removal system to displace an effective ad the night before the election.

Operation 1057 describes causing the one or more cognitive symbols substantially to vanish from the visual display (e.g. marking circuitry 394 marking a logo, an ad to be deleted, or an occluding image to be added; and applying the marking so that the symbols substantially vanish). In some embodiments, a symbol can vanish from a virtual reality display for some users even while it continues to be visible for other users. In some embodiments, a symbol disappearance is signaled but is not necessarily implemented, for example, when a required confirmation does not arrive within a reasonable timeout period.

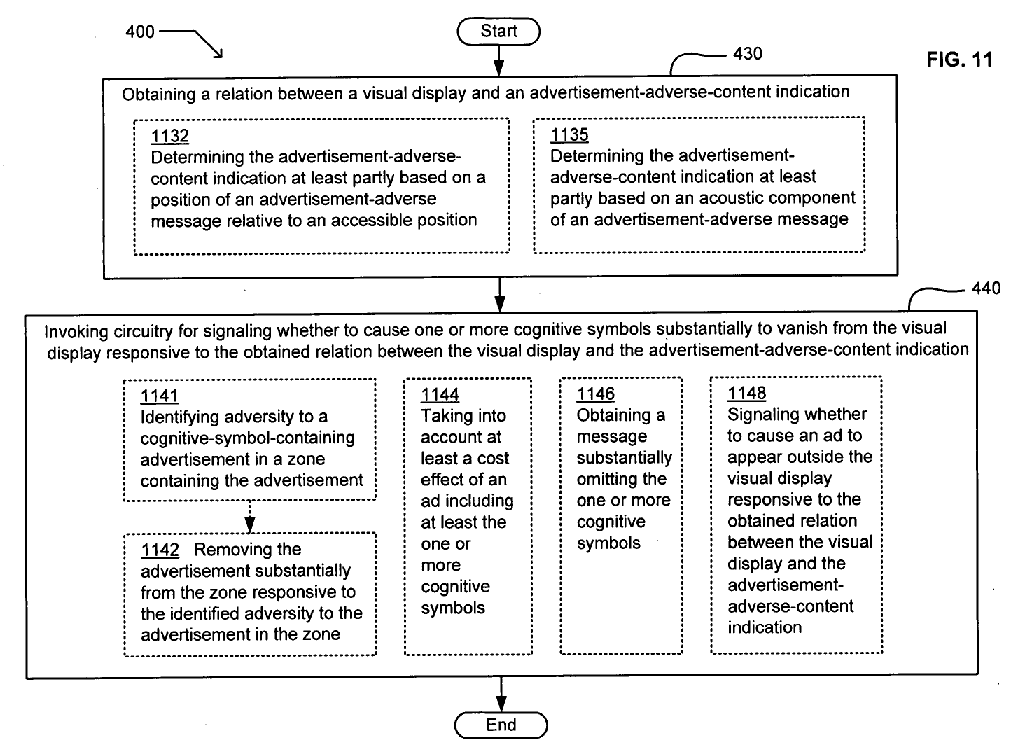

Referring now to FIG. 11, there are shown several variants of the flow 400 of FIG. 4 or 10. Operation 430—obtaining a relation between a visual display and an advertisement-adverse-content indication—may include one or more of operation 1132 or operation 1135. Operation 440—invoking circuitry for signaling whether to cause one or more cognitive symbols substantially to vanish from the visual display responsive to the obtained relation between the visual display and the advertisement-adverse-content indication—may include one or more of the following operations: 1141, 1142, 1144, 1146, or 1148.

Operation 1132 describes determining the advertisement-adverse-content indication at least partly based on a position of an advertisement-adverse message relative to an accessible position (e.g. position evaluator 234 adjusting cost effect 246 or other evaluations 245 responsive to whether the accessible position is above, even with, or below advertisement-adverse message). Absent high-draw links or other visitor behavior modeling, for example, image evaluator 231 can optionally assign a higher value to whichever is higher. Alternatively or additionally, image evaluator 231 can apply a premium responsive to detecting cognitive symbols 32 or other accessible positions are (a) initially onscreen or (b) above all other ads to be shown in visual display 30, for example. Alternatively or additionally, image evaluator 231 likewise can optionally take an apparent advertisement-adverse message area size into account.

Operation 1135 describes determining the advertisement-adverse-content indication at least partly based on an acoustic component of an advertisement-adverse message (e.g. acoustic analyzer 294 identifying one or more loud noises 39 such as a storm or a concert in the one or more recognizable features 236). This can occur, for example, in embodiments in which evaluation circuitry 210 implements content evaluator 710. Loud noises can bear against advertisements that rely upon speech, for example, and may prompt at least a simplification of an ad.

Operation 1141 describes identifying adversity to a cognitive-symbol-containing advertisement in a zone containing the advertisement (e.g. at least receiver 398 of response circuitry 320 receiving an identification of gambling- or alcohol-related images, showing an ad for a church, on local display screen 330). In some embodiments, this mode of identifying can be facilitated by categories 249 or other adversity description provided by image evaluator 231, for example.

Operation 1142 describes removing the advertisement substantially from the zone responsive to the identified adversity to the advertisement in the zone (e.g. ad manager 357 substituting or superseding a poorly-suited ad with an ad that is more harmonious with the identified adversity). If loud music enters the environment of a basic talking character ad, for example, the talking character can be replaced with a dancing logo synchronized to the beat or with a librarian figure shushing passers-by via external delivery module 8.

Operation 1144 describes taking into account at least a cost effect of an ad including at least the one or more cognitive symbols (e.g. venue manager 319 and receiver 398 jointly deciding which among several venues is suitable for displaying the cognitive-symbol-containing ad partly based on one or more cost effects 246). In some embodiments, at least venue manager 319 can decide to continue an ad in a $2/month space while terminating a substantively similar space in a $1/month space. This can occur responsive to estimating that the former space has an approximate market impact more than an order of magnitude larger than that of the latter space, for example.

Operation 1146 describes obtaining a message substantially omitting the one or more cognitive symbols (e.g. ad manager 357 selecting a more reserved ad for presentation from a stored repertoire). This can occur in system 100, for example, responsive to detecting “AARP” as input data 116 or on visual display 30.

Operation 1148 describes signaling whether to cause an ad to appear outside the visual display responsive to the obtained relation between the visual display and the advertisement-adverse-content indication (e.g. venue manager 319 and transmitter 382 jointly suggesting to a remote user that an ad be relocated to another venue). In some embodiments, such a suggestion is made responsive to a comparison that takes into account a multivariate comparison between two or more venues.

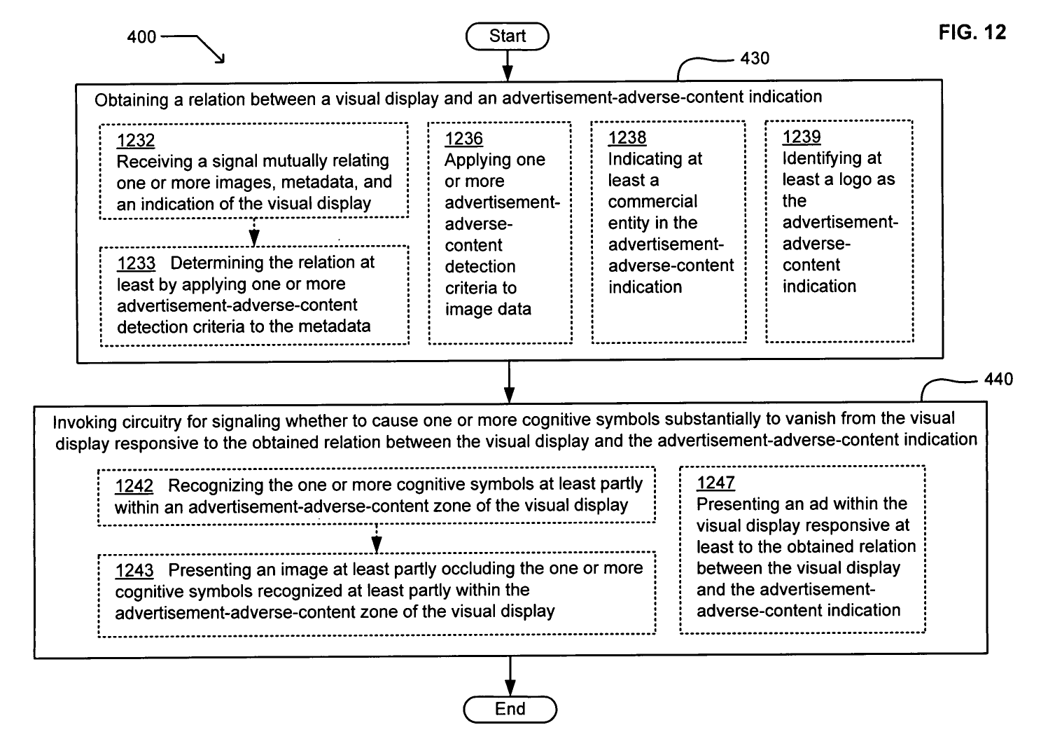

Referring now to FIG. 12, there are shown several variants of the flow 400 of FIG. 4, 10, or 11. Operation 430—obtaining a relation between a visual display and an advertisement-adverse-content indication—may include one or more of the following operations: 1232, 1233, 1236, 1238, or 1239. Operation 440—invoking circuitry for signaling whether to cause one or more cognitive symbols substantially to vanish from the visual display responsive to the obtained relation between the visual display and the advertisement-adverse-content indication—may include one or more of the following operations: 1242, 1243, or 1247.

Operation 1232 describes receiving a signal mutually relating one or more images, metadata, and an indication of the visual display (e.g. receiver 298 receiving one or more records containing a video segment, a size of the video segment in megabytes, and an indication of a remote display). In some embodiments, an adversity to a very large ad can be at least partly based on a connection quality of a conduit (such as conduit 888) coupling the ad source and destination (from remote server 818 to primary delivery module 4, e.g.). An otherwise very effective ad can be prohibitive, for example, if sending it would be too expensive or time-consuming.

Operation 1233 describes determining the relation at least by applying one or more advertisement-adverse-content detection criteria to the metadata (e.g. metadata evaluator 239 evaluating a video signal and identifying a caption containing “Exxon” and “increase” being adverse to an ad showing a Chevy Suburban). This might bear toward a removal of the ad or a substitution of an ad showing a Chevy Cavalier, for example.

Operation 1236 describes applying one or more advertisement-adverse-content detection criteria to image data (e.g. image evaluator 231 determining whether embedded images are graphic or otherwise strongly emotional, competitive, or the like). Political images can be detected adequately by pattern matching to shapes of states or nations, for example, in the absence of meteorological symbol indications like sketches of clouds or large-print two-digit numbers.

Operation 1238 describes indicating at least a commercial entity in the advertisement-adverse-content indication (e.g. symbol identifier 233 indicating a phrase that storage manager 251 can identify as a company name associated with one or more evaluations 245 indicating a level of adversity). In some embodiments, storage manager 251 can recognize the phrase “Business Machines” as apparently relating to IBM Corporation.

Operation 1239 describes identifying at least a logo as the advertisement-adverse-content indication (e.g. symbol identifier 233 identifying logo 33). In some embodiments, a logo identification is confirmed or otherwise facilitated by words shown or spoken while the logo is displayed. In some embodiments, symbol identifier 233 performs an identification by associating at least an identity (such as the logo owner's name) and a confidence indicator (such as a likelihood estimate of the name's correctness).

Operation 1242 describes recognizing the one or more cognitive symbols at least partly within an advertisement-adverse-content zone of the visual display (e.g. symbol identifier 233 and receiver 398 jointly analyzing a screen image responsive to detecting the screen image optically). This can occur, for example, in an embodiment of system 300 in which visual display's output is externally detected as detectable phenomena 40.

Operation 1243 describes presenting an image at least partly occluding the one or more cognitive symbols recognized at least partly within the advertisement-adverse-content zone of the visual display (e.g. symbol occluder 395 at least partly blocking an occurrence of “Finger Lickin' Good” recognized by slogan identifier 295). In some embodiments, the symbol occlusion can feature a substantially neutral entity (e.g. entity emulator 391 presenting a smokescreen or non-player character occluding the slogan from the view of a user). In other embodiments, the symbol occlusion can feature a competing message (e.g. ad manager 357 presenting an ad including a slogan of “Have It Your Way” at least partly occluding “Finger Lickin' Good”).

Operation 1247 describes presenting an ad within the visual display responsive at least to the obtained relation between the visual display and the advertisement-adverse-content indication (e.g. entity emulator 391 can present message 389 as a giant shoe with a Nike swoop responsive to detecting “Reebok” in visual display 30). Alternatively or additionally, message 389 can include one or more additional sequence actions, such as showing a “Just Do It” slogan briefly.

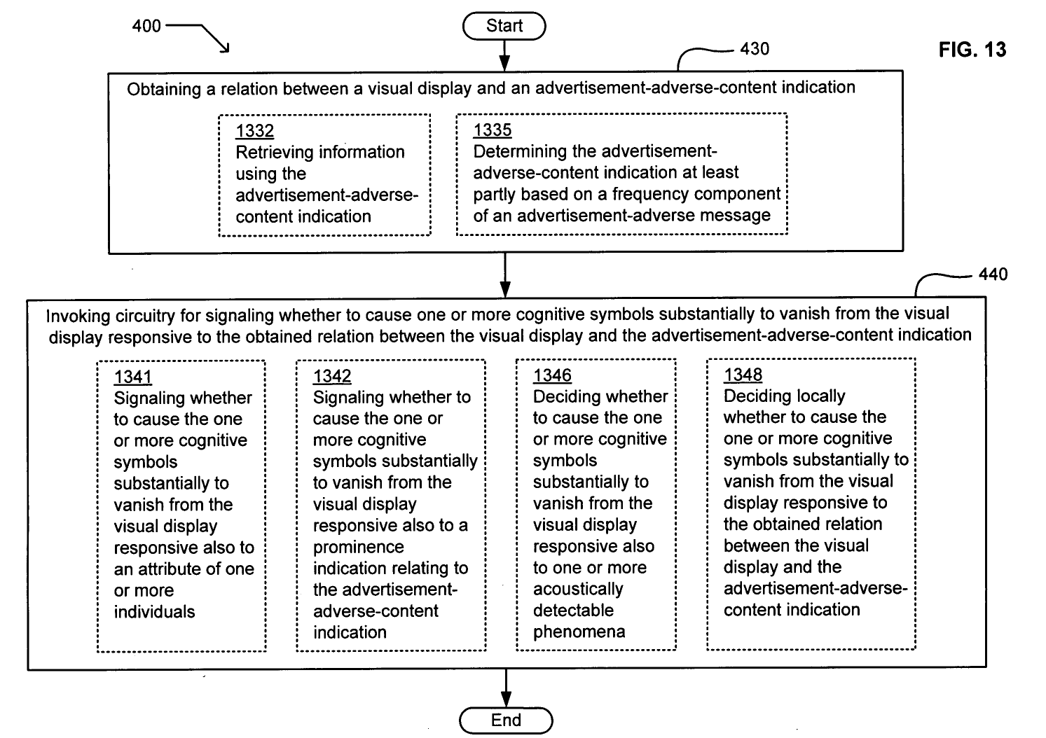

Referring now to FIG. 13, there are shown several variants of the flow 400 of FIG. 4, 10, 11, or 12. Operation 430—obtaining a relation between a visual display and an advertisement-adverse-content indication—may include one or more of operation 1332 or operation 1335. Operation 440—invoking circuitry for signaling whether to cause one or more cognitive symbols substantially to vanish from the visual display responsive to the obtained relation between the visual display and the advertisement-adverse-content indication—may include one or more of the following operations: 1341, 1342, 1346, or 1348.

Operation 1332 describes retrieving information using the advertisement-adverse-content indication (e.g. data handling circuitry 250 using “Medtronic” and one or more other portions of the advertisement-adverse-content indication in a search string). Data retrieved from using the search string can target news about Medtronic, for example, that can help a user refine an adversity score manually. In some embodiments, text analyzer 238 extracts “Medtronic” and similar entity identifiers from text in the content, such as by screening for capitalization or by requesting a remote server for a term recognition operation via transmitter 299, for example.

Operation 1335 describes determining the advertisement-adverse-content indication at least partly based on a frequency component of an advertisement-adverse message (e.g. frequency evaluator 292 recognizing one or more of voice data, jingles, a color, a trade dress component, or the like). In some embodiments, one or more advertisement-adverse-content indications are determined periodically or otherwise on an ongoing or repeated basis with one or more components of pattern comparator 290. Alternatively or additionally, storage manager 251 can record advertisement-adverse-content indications in storage 252.

Operation 1341 describes signaling whether to cause the one or more cognitive symbols substantially to vanish from the visual display responsive also to an attribute of one or more individuals (e.g. gesture evaluator 312 pivotally influencing ratings 247 to sway a decision to withdraw a pharmaceutical ad, responsive to recognizing distracting actions 38 like wild dancing). This can occur, for example, in an embodiment in which at least evaluation circuitry 210 implements content evaluator 710. In some embodiments, image evaluator 231 similarly permits taking facial actions or positions into account, like crying or frowning.

Operation 1342 describes signaling whether to cause the one or more cognitive symbols substantially to vanish from the visual display responsive also to a prominence indication relating to the advertisement-adverse-content indication (e.g. at least prominence evaluator 325 influencing the signaling decision by affecting one or more levels of level indicator 326). In some embodiments, the levels may relate to a size, volume, viewing angle, quality, or the like.

Operation 1346 describes deciding whether to cause the one or more cognitive symbols substantially to vanish from the visual display responsive also to one or more acoustically detectable phenomena (e.g. acoustic analyzer 294 and receiver 398 jointly signaling an ad sequence responsive to detecting mens' voices after work in a shopping mall in early February). The sequence can include four words each shown on local display screen 330 one at a time, for example: “Say . . . It . . . With . . . Flowers.” This can occur in system 700, for example, in which voice identifier 297 discerns the voices among detectable phenomena 40.

Operation 1348 describes deciding locally whether to cause the one or more cognitive symbols substantially to vanish from the visual display responsive to the obtained relation between the visual display and the advertisement-adverse-content indication (e.g. at least pattern comparator 290 deciding whether to substitute a responsive commercial message for “Eat Fresh” in a specific browser window or display screen portion). In some embodiments, the responsive commercial message can include commentary relating to a currently- or recently-detected McDonald's® slogan that is more adverse to “Eat Fresh” than to the responsive commercial message.

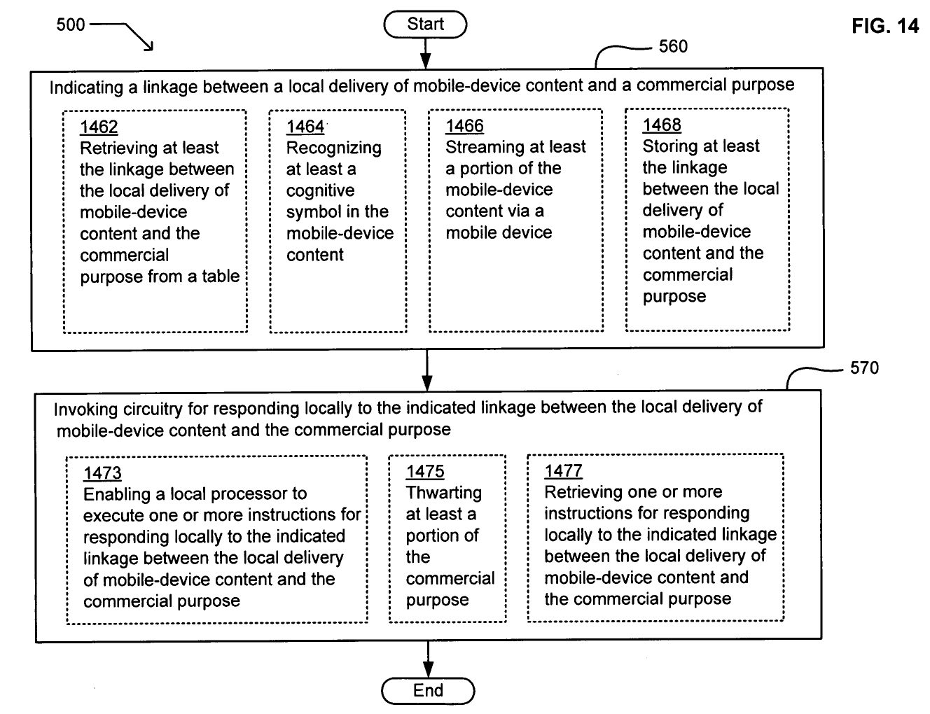

Referring now to FIG. 14, there are shown several variants of the flow 500 of FIG. 5. Operation 560—indicating a linkage between a local delivery of mobile-device content and a commercial purpose—may include one or more of the following operations: 1462, 1464, 1466, or 1468. Operation 570—invoking circuitry for responding locally to the indicated linkage between the local delivery of mobile-device content and the commercial purpose—may include one or more of the following operations: 1473, 1475, or 1477.

Operation 1462 describes retrieving at least the linkage between the local delivery of mobile-device content and the commercial purpose from a table (e.g. memory manager 256 and storage manager 251 jointly retrieving a record from table 253 defining a content of Ad # 252571C and a time, place, and terms relating to a prospective delivery of the ad). In some embodiments, a prospective delivery of an adverse ad can be used for evaluating its adversity and withdrawing or modifying the friendly ad before the adverse ad arrives.

Operation 1464 describes recognizing at least a cognitive symbol in the mobile-device content (e.g. pattern comparator 290 identifying spoken sounds of the title “President Bush”). In some embodiments, one or more such phrases can cause pattern comparator to associate one of the genres 237, such as “news” or “politics,” with that venue or vicinity). In some embodiments, a “news” genre can be evaluated as neutral content 42 or otherwise for facilitating one or more flows as described herein.

Operation 1466 describes streaming at least a portion of the mobile-device content via a mobile device (e.g. streaming circuitry 217 playing “Whiskey Lullaby” via mobile device 70 roughly contemporaneously with acoustic analyzer 294 or metadata evaluator 239 detecting “whiskey” in the lyrics). In some embodiments, such a word might trigger an immediate removal of a Jack Daniel's ad from the vicinity. In other embodiments, an ordinary slogan may be removed in favor of a message about drinking in moderation. In some embodiments, pattern comparator 290 may use frequency evaluator 292 to recognize a variety of common attributes of sad melodies, and to make a similar ad symbol change responsive to any roughly contemporaneous sad melody, announcement, or other event in the streaming or other mobile-device content.

Operation 1468 describes storing at least the linkage between the local delivery of mobile-device content and the commercial purpose (e.g. storage manager 251 recording an occurrence of ads or other events in mobile-device content logically related to a commercial purpose, friendly or otherwise). In the above-referenced examples relating to alcoholic beverages, for example, a preponderance of unfriendly content may correlate with a specific shopping mall or radio broadcast and with weekday afternoons. Aggregation facilitates identifying such trends and with responding to them quickly, such as by control circuitry 381 invoking transmitter 382 for inviting subjects in those venues to participate in a device-implemented market research questionnaire.

Operation 1473 describes enabling a local processor to execute one or more instructions for responding locally to the indicated linkage between the local delivery of mobile-device content and the commercial purpose (e.g. memory 352 receiving one or more instructions 359 from storage manager 355 for execution by local processor 310). This can occur, for example, in embodiments in which mobile device 70 of FIG. 1 includes one or more applets for execution by local processor 310, permitting a instantaneous response to a text-based ad threat or opportunity easily identified in the mobile-device content.

Operation 1475 describes thwarting at least a portion of the commercial purpose (e.g. image generator 393 displaying an attack ad, graphic image, or other substantial distraction locally during a key competitor's ad in the local delivery of the mobile-device content). In some embodiments, the above-described technique can be used intermittently or in response to an indication that the local delivery is occurring in a vicinity of a client's retail location.

Operation 1477 describes retrieving one or more instructions for responding locally to the indicated linkage between the local delivery of mobile-device content and the commercial purpose (e.g. memory manager 351 retrieving instructions 359 from a phone service provider to memory 352 of a cellular telephone or other mobile device 70 for preserving a relationship between the phone service provider and a user of the device). In some embodiments, mobile device 70 uses instructions 359 for enhancing a service of a prospective or preferred service plan member, for example, or for thwarting an ad of another provider of mobile device service. In some embodiments, instructions 359 implement one or more of the optional items in evaluation circuitry 210 (in FIG. 2) or one or more of the items shown on the left side of response circuitry 320 (in FIG. 3).

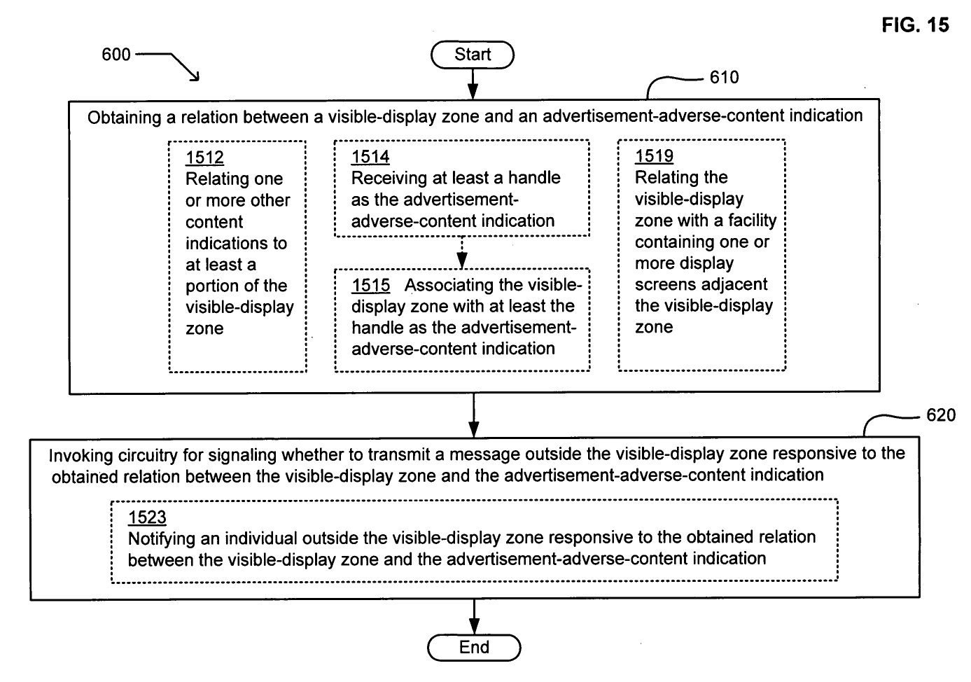

Referring now to FIG. 15, there are shown several variants of the flow 600 of FIG. 6. Operation 610—obtaining a relation between a visible-display zone and an advertisement-adverse-content indication—may include one or more of the following operations: 1512, 1514, 1515, or 1519. Operation 620—invoking circuitry for signaling whether to transmit a message outside the visible-display zone responsive to the obtained relation between the visible-display zone and the advertisement-adverse-content indication—may optionally include operation 1523.

Operation 1512 describes relating one or more other content indications to at least a portion of the visible-display zone (e.g. image evaluator 231 relating an active window of local display screen 330 with a “no adversity” indication and with other indications such as “Snoopy” or other personas 235). In some embodiments, “other content” indications can include “comedy” or other genres 237 or “iPod leakage” or other device signals 243.

Operation 1514 describes receiving at least a handle as the advertisement-adverse-content indication (e.g. receiver 298 receiving a website hyperlink, program name, or other process handles 248 with “PG-13” as the advertisement-adverse-content indication). The website hyperlink can lead a user to a definition of the “PG-13” rating or to a list of “PG-13” content, for example. In some embodiments, the program name can identify a code module for applying a “PG-13” standard for screening content arriving at primary delivery module 4. Such handles can be used proactively, and optionally automatically, for detecting or adjusting an advertisement with a potentially objectionable component.

In some embodiments, a similar handle can be used for a similar detection or adjustment of content or for emulating a firewall that may affect the appearance of an advertisement. Alternatively or additionally, a similar handle can identify which code module(s) of pattern comparator 290 detected part or all of an advertisement-adverse-content indication. In some embodiments, a mixed signal or other questionable adversity indication (e.g. a false positive, detecting apparent adversity absent any actual adversity) can prompt a code revision signal to facilitate improvements to one or more component portions of pattern comparator 290.

Operation 1515 describes associating the visible-display zone with at least the handle as the advertisement-adverse-content indication (e.g. image evaluator 231 remotely associating shaded zone 905 or a portion thereof with “Headquarters” or some other text name of a premises at least partly overlapping zone 905). This can optionally occur, for example, in embodiments in which at least response circuitry 230 resides remote from the visible-display zone (at external system 5, e.g.). Alternatively or additionally, in some embodiments, metadata evaluator 239 can distill the handle from content delivered via external delivery module 8, such as by decompilation or other analysis of the content.

Operation 1519 describes relating the visible-display zone with a facility containing one or more display screens adjacent the visible-display zone (e.g. table 253 providing a record associating visual display 30 with vicinity 105 and with “ground floor” or a building address). In some embodiments, visual display 30 can be identified in such a record by an Internet Protocol (IP) address or other circuitry identifiers 258, for example.

Operation 1523 describes notifying an individual outside the visible-display zone responsive to the obtained relation between the visible-display zone and the advertisement-adverse-content indication (e.g. network interface 313 and storage manager 355 jointly sending a message via external delivery module 8, responsive to an evaluation that vicinity 105 is moderately adverse to an advertisement). In some embodiments, external delivery module comprises a user interface enabling one or more individuals 14 to retrieve the message later. Alternatively or additionally, the above-described systems and methods for performing variants of flow 600 can be configured with instructions in memory or other circuitry for performing one or more of the above-described flows of FIG. 10, 11, 12, 13, or 14 as well.

It will be understood that variations in business models relating to the technologies described herein may prove advantageous, for example in situations in which an information systems consultant or other service provider acts for the benefit of one or more clients or interests to achieve such technologies collectively. Such arrangements can facilitate organizational or tool specialization and cost effectiveness, for example, across distributed networks in the global marketplace. Those skilled in the art will recognize that such beneficial interaction creates a commercial web constituting a single de facto entity of two or more interacting participants cooperatively implementing the teachings herein, within the scope and spirit of the claimed invention.

Those having skill in the art will recognize that the state of the art has progressed to the point where there is little distinction left between hardware and software implementations of aspects of systems; the use of hardware or software is generally (but not always, in that in certain contexts the choice between hardware and software can become significant) a design choice representing cost vs. efficiency tradeoffs. Those having skill in the art will appreciate that there are various vehicles by which processes and/or systems and/or other technologies described herein can be effected (e.g., hardware, software, and/or firmware), and that the preferred vehicle will vary with the context in which the processes and/or systems and/or other technologies are deployed. For example, if an implementer determines that speed and accuracy are paramount, the implementer may opt for a mainly hardware and/or firmware vehicle; alternatively, if flexibility is paramount, the implementer may opt for a mainly software implementation; or, yet again alternatively, the implementer may opt for some combination of hardware, software, and/or firmware. Hence, there are several possible vehicles by which the processes and/or devices and/or other technologies described herein may be effected, none of which is inherently superior to the other in that any vehicle to be utilized is a choice dependent upon the context in which the vehicle will be deployed and the specific concerns (e.g., speed, flexibility, or predictability) of the implementer, any of which may vary. Those skilled in the art will recognize that optical aspects of implementations will typically employ optically-oriented hardware, software, and or firmware.

The foregoing detailed description has set forth various embodiments of the devices and/or processes via the use of block diagrams, flowcharts, and/or examples. Insofar as such block diagrams, flowcharts, and/or examples contain one or more functions and/or operations, it will be understood by those within the art that each function and/or operation within such block diagrams, flowcharts, or examples can be implemented, individually and/or collectively, by a wide range of hardware, software, firmware, or virtually any combination thereof. In one embodiment, several portions of the subject matter described herein may be implemented via Application Specific Integrated Circuits (ASICs), Field Programmable Gate Arrays (FPGAs), digital signal processors (DSPs), or other integrated formats. However, those skilled in the art will recognize that some aspects of the embodiments disclosed herein, in whole or in part, can be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein are capable of being distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a Compact Disc (CD), a Digital Video Disk (DVD), a digital tape, a computer memory, etc.; and a transmission type medium such as a digital and/or an analog communication medium (e.g., a fiber optic cable, a waveguide, a wired communications link, a wireless communication link, etc.).

While particular aspects of the present subject matter described herein have been shown and described, it will be apparent to those skilled in the art that, based upon the teachings herein, changes and modifications may be made without departing from this subject matter described herein and its broader aspects and, therefore, the appended claims are to encompass within their scope all such changes and modifications as are within the true spirit and scope of this subject matter described herein.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.” Moreover, “can” and “optionally” and other permissive terms are used herein for describing optional features of various embodiments. These terms likewise describe selectable or configurable features generally, unless the context dictates otherwise.

The herein described aspects depict different components contained within, or connected with, different other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected,” or “operably coupled,” to each other to achieve the desired functionality. Any two components capable of being so associated can also be viewed as being “operably couplable” to each other to achieve the desired functionality. Specific examples of operably couplable include but are not limited to physically mateable and/or physically interacting components and/or wirelessly.

1. A method comprising:
obtaining a relation between a visual display and an advertisement-adverse-content indication; and
invoking circuitry for signaling whether to cause one or more cognitive symbols substantially to vanish from the visual display responsive to the obtained relation between the visual display and the advertisement-adverse-content indication.

2-8. (canceled)

9. The method of claim 1 in which invoking circuitry for signaling whether to cause one or more cognitive symbols substantially to vanish from the visual display responsive to the obtained relation between the visual display and the advertisement-adverse-content indication comprises:
identifying adversity to a cognitive-symbol-containing advertisement in a zone containing the advertisement; and
removing the advertisement substantially from the zone responsive to the identified adversity to the advertisement in the zone.

10. The method of claim 1 in which invoking circuitry for signaling whether to cause one or more cognitive symbols substantially to vanish from the visual display responsive to the obtained relation between the visual display and the advertisement-adverse-content indication comprises:
taking into account at least a cost effect of an ad including at least the one or more cognitive symbols.

11-12. (canceled)

13. The method of claim 1 in which obtaining a relation between a visual display and an advertisement-adverse-content indication comprises:
receiving a signal mutually relating one or more images, metadata, and an indication of the visual display; and
determining the relation at least by applying one or more advertisement-adverse-content detection criteria to the metadata.

14-15. (canceled)

16. The method of claim 1 in which obtaining a relation between a visual display and an advertisement-adverse-content indication comprises:
identifying at least a logo as the advertisement-adverse-content indication.

17. (canceled)

18. The method of claim 1 in which invoking circuitry for signaling whether to cause one or more cognitive symbols substantially to vanish from the visual display responsive to the obtained relation between the visual display and the advertisement-adverse-content indication comprises:
presenting an ad within the visual display responsive at least to the obtained relation between the visual display and the advertisement-adverse-content indication.

19. The method of claim 1 in which obtaining a relation between a visual display and an advertisement-adverse-content indication comprises:
retrieving information using the advertisement-adverse-content indication.

20. The method of claim 1 in which obtaining a relation between a visual display and an advertisement-adverse-content indication comprises:
determining the advertisement-adverse-content indication at least partly based on a frequency component of an advertisement-adverse message.

21. The method of claim 1 in which invoking circuitry for signaling whether to cause one or more cognitive symbols substantially to vanish from the visual display responsive to the obtained relation between the visual display and the advertisement-adverse-content indication comprises:
signaling whether to cause the one or more cognitive symbols substantially to vanish from the visual display responsive also to an attribute of one or more individuals.

22. The method of claim 1 in which invoking circuitry for signaling whether to cause one or more cognitive symbols substantially to vanish from the visual display responsive to the obtained relation between the visual display and the advertisement-adverse-content indication comprises:
signaling whether to cause the one or more cognitive symbols substantially to vanish from the visual display responsive also to a prominence indication relating to the advertisement-adverse-content indication.

23. The method of claim 1 in which invoking circuitry for signaling whether to cause one or more cognitive symbols substantially to vanish from the visual display responsive to the obtained relation between the visual display and the advertisement-adverse-content indication comprises:
deciding whether to cause the one or more cognitive symbols substantially to vanish from the visual display responsive also to one or more acoustically detectable phenomena.

24. The method of claim 1 in which invoking circuitry for signaling whether to cause one or more cognitive symbols substantially to vanish from the visual display responsive to the obtained relation between the visual display and the advertisement-adverse-content indication comprises:
deciding locally whether to cause the one or more cognitive symbols substantially to vanish from the visual display responsive to the obtained relation between the visual display and the advertisement-adverse-content indication.

25-32. (canceled)

33. A method comprising:
obtaining a relation between a visible-display zone and an advertisement-adverse-content indication; and
invoking circuitry for signaling whether to transmit a message outside the visible-display zone responsive to the obtained relation between the visible-display zone and the advertisement-adverse-content indication.

34. The method of claim 33 in which obtaining a relation between a visible-display zone and an advertisement-adverse-content indication comprises:
relating one or more other content indications to at least a portion of the visible-display zone.

35. The method of claim 33 in which obtaining a relation between a visible-display zone and an advertisement-adverse-content indication comprises:
receiving at least a handle as the advertisement-adverse-content indication; and
associating the visible-display zone with at least the handle as the advertisement-adverse-content indication.

36-37. (canceled)

38. A system comprising:
circuitry for obtaining a relation between a visual display and an advertisement-adverse-content indication; and
circuitry for signaling whether to cause one or more cognitive symbols substantially to vanish from the visual display responsive to the obtained relation between the visual display and the advertisement-adverse-content indication.

39. The system of claim 38 in which the circuitry for obtaining a relation between a visual display and an advertisement-adverse-content indication comprises:
circuitry for determining the advertisement-adverse-content indication at least partly based on a visual component of an advertisement-adverse message.

40-43. (canceled)

44. The system of claim 38 in which the circuitry for obtaining a relation between a visual display and an advertisement-adverse-content indication comprises:
circuitry for determining the advertisement-adverse-content indication at least partly based on a position of an advertisement-adverse message relative to an accessible position.

45. The system of claim 38 in which the circuitry for obtaining a relation between a visual display and an advertisement-adverse-content indication comprises:
circuitry for determining the advertisement-adverse-content indication at least partly based on an acoustic component of an advertisement-adverse message.

46-47. (canceled)

48. The system of claim 38 in which the circuitry for signaling whether to cause one or more cognitive symbols substantially to vanish from the visual display responsive to the obtained relation between the visual display and the advertisement-adverse-content indication comprises:
circuitry for obtaining a message substantially omitting the one or more cognitive symbols.

49. The system of claim 38 in which the circuitry for signaling whether to cause one or more cognitive symbols substantially to vanish from the visual display responsive to the obtained relation between the visual display and the advertisement-adverse-content indication comprises:
circuitry for signaling whether to cause an ad to appear outside the visual display responsive to the obtained relation between the visual display and the advertisement-adverse-content indication.

50-51. (canceled)

52. The system of claim 38 in which the circuitry for obtaining a relation between a visual display and an advertisement-adverse-content indication comprises:
circuitry for indicating at least a commercial entity in the advertisement-adverse-content indication.

53. (canceled)

54. The system of claim 38 in which the circuitry for signaling whether to cause one or more cognitive symbols substantially to vanish from the visual display responsive to the obtained relation between the visual display and the advertisement-adverse-content indication comprises:
circuitry for recognizing the one or more cognitive symbols at least partly within an advertisement-adverse-content zone of the visual display; and
circuitry for presenting an image at least partly occluding the one or more cognitive symbols recognized at least partly within the advertisement-adverse-content zone of the visual display.

55. The system of claim 38 in which the circuitry for signaling whether to cause one or more cognitive symbols substantially to vanish from the visual display responsive to the obtained relation between the visual display and the advertisement-adverse-content indication comprises:
circuitry for presenting an ad within the visual display responsive at least to the obtained relation between the visual display and the advertisement-adverse-content indication.

56. The system of claim 38 in which the circuitry for obtaining a relation between a visual display and an advertisement-adverse-content indication comprises:
circuitry for retrieving information using the advertisement-adverse-content indication.

57. (canceled)

58. The system of claim 38 in which the circuitry for signaling whether to cause one or more cognitive symbols substantially to vanish from the visual display responsive to the obtained relation between the visual display and the advertisement-adverse-content indication comprises:
circuitry for signaling whether to cause the one or more cognitive symbols substantially to vanish from the visual display responsive also to an attribute of one or more individuals.

59. The system of claim 38 in which the circuitry for signaling whether to cause one or more cognitive symbols substantially to vanish from the visual display responsive to the obtained relation between the visual display and the advertisement-adverse-content indication comprises:
circuitry for signaling whether to cause the one or more cognitive symbols substantially to vanish from the visual display responsive also to a prominence indication relating to the advertisement-adverse-content indication.

60. (canceled)

61. The system of claim 38 in which the circuitry for signaling whether to cause one or more cognitive symbols substantially to vanish from the visual display responsive to the obtained relation between the visual display and the advertisement-adverse-content indication comprises:
circuitry for deciding locally whether to cause the one or more cognitive symbols substantially to vanish from the visual display responsive to the obtained relation between the visual display and the advertisement-adverse-content indication.

62-69. (canceled)

70. A system comprising:
circuitry for obtaining a relation between a visible-display zone and an advertisement-adverse-content indication; and
circuitry for signaling whether to transmit a message outside the visible-display zone responsive to the obtained relation between the visible-display zone and the advertisement-adverse-content indication.

71-73. (canceled)

74. The system of claim 70 in which the circuitry for signaling whether to transmit a message outside the visible-display zone responsive to the obtained relation between the visible-display zone and the advertisement-adverse-content indication comprises:
circuitry for notifying an individual outside the visible-display zone responsive to the obtained relation between the visible-display zone and the advertisement-adverse-content indication.

75. A system comprising:
means for obtaining a relation between a visual display and an advertisement-adverse-content indication; and
means for signaling whether to cause one or more cognitive symbols substantially to vanish from the visual display responsive to the obtained relation between the visual display and the advertisement-adverse-content indication.

76. The system of claim 75 in which the means for obtaining a relation between a visual display and an advertisement-adverse-content indication comprises:
means for determining the advertisement-adverse-content indication at least partly based on a visual component of an advertisement-adverse message.

77-81. (canceled)

82. The system of claim 75 in which the means for obtaining a relation between a visual display and an advertisement-adverse-content indication comprises:
means for determining the advertisement-adverse-content indication at least partly based on an acoustic component of an advertisement-adverse message.

83. The system of claim 75 in which the means for signaling whether to cause one or more cognitive symbols substantially to vanish from the visual display responsive to the obtained relation between the visual display and the advertisement-adverse-content indication comprises:
means for identifying adversity to a cognitive-symbol-containing advertisement in a zone containing the advertisement; and
means for removing the advertisement substantially from the zone responsive to the identified adversity to the advertisement in the zone.

84. The system of claim 75 in which the means for signaling whether to cause one or more cognitive symbols substantially to vanish from the visual display responsive to the obtained relation between the visual display and the advertisement-adverse-content indication comprises:
means for taking into account at least a cost effect of an ad including at least the one or more cognitive symbols.

85. The system of claim 75 in which the means for signaling whether to cause one or more cognitive symbols substantially to vanish from the visual display responsive to the obtained relation between the visual display and the advertisement-adverse-content indication comprises:
means for obtaining a message substantially omitting the one or more cognitive symbols.

86. The system of claim 75 in which the means for signaling whether to cause one or more cognitive symbols substantially to vanish from the visual display responsive to the obtained relation between the visual display and the advertisement-adverse-content indication comprises:
means for signaling whether to cause an ad to appear outside the visual display responsive to the obtained relation between the visual display and the advertisement-adverse-content indication.

87. The system of claim 75 in which the means for obtaining a relation between a visual display and an advertisement-adverse-content indication comprises:
means for receiving a signal mutually relating one or more images, metadata, and an indication of the visual display; and
means for determining the relation at least by applying one or more advertisement-adverse-content detection criteria to the metadata.

88. (canceled)

89. The system of claim 75 in which the means for obtaining a relation between a visual display and an advertisement-adverse-content indication comprises:
means for indicating at least a commercial entity in the advertisement-adverse-content indication.

90-93. (canceled)

94. The system of claim 75 in which the means for obtaining a relation between a visual display and an advertisement-adverse-content indication comprises:
means for determining the advertisement-adverse-content indication at least partly based on a frequency component of an advertisement-adverse message.

95-96. (canceled)

97. The system of claim 75 in which the means for signaling whether to cause one or more cognitive symbols substantially to vanish from the visual display responsive to the obtained relation between the visual display and the advertisement-adverse-content indication comprises:
means for deciding whether to cause the one or more cognitive symbols substantially to vanish from the visual display responsive also to one or more acoustically detectable phenomena.

98-106. (canceled)

107. A system comprising:
means for obtaining a relation between a visible-display zone and an advertisement-adverse-content indication; and
means for signaling whether to transmit a message outside the visible-display zone responsive to the obtained relation between the visible-display zone and the advertisement-adverse-content indication.

108. The system of claim 107 in which the means for obtaining a relation between a visible-display zone and an advertisement-adverse-content indication comprises:
means for relating one or more other content indications to at least a portion of the visible-display zone.

109. (canceled)

110. The system of claim 107 in which the means for obtaining a relation between a visible-display zone and an advertisement-adverse-content indication comprises:
means for relating the visible-display zone with a facility containing one or more display screens adjacent the visible-display zone.

111. (canceled)
